(19) United States
(12) Patent Application Publication
(10) Pub. No.: US 2006/0072051 A1
(43) Pub. Date: Apr. 6, 2006

(54) Backlight assembly and liquid crystal display device having the same

(76) Inventors: Seock-Hwan Kang, Suwon-si (KR); Yong-Woo Lee, Suwon-si (KR); Jae-Sang Lee, Suwon-si (KR); Hea-Chun Lee, Suwon-si (KR); Jin-Ho Ha, Suwon-si (KR)

Correspondence Address: CANTOR COLBURN, LLP, 55 GRIFFIN ROAD SOUTH, BLOOMFIELD, CT, 06002, US

(21) Appl. No.: 11/243,564

(22) Filed: Oct. 5, 2005

(30) Foreign Application Priority Data
Oct. 5, 2004 (KR) 2004-79218

(51) Int. Cl. G02F 1/1333

(52) U.S. Cl. 349/58

(57) ABSTRACT

A backlight assembly includes a bottom chassis, a planar fluorescent lamp, a mold and an inverter. The bottom chassis includes a bottom portion and a side portion. The planar fluorescent lamp generates planar-light. The bottom chassis receives the planar fluorescent lamp. The mold fixes the planar fluorescent lamp such that a gap is generated between a portion of the mold and the planar fluorescent lamp to absorb impact between the mold and the planar fluorescent lamp. The inverter generates discharge voltages to drive the planar fluorescent lamp.

This application claims priority to Korean Patent Application No.2004-79218 filed on Oct. 5, 2004, and all the benefits accruing therefrom under 35 U.S.C. §119, and the contents of which in its entirety are herein incorporated by reference.

### BACKGROUND OF THE INVENTION

1. Field of the Invention

The present invention relates to a backlight assembly and a liquid crystal display device having the backlight assembly. More particularly, the present invention relates to a backlight assembly that generates planar-light and a liquid crystal display device having the backlight assembly.

2. Description of the Related Art

Generally, a liquid crystal display (LCD) device displays images using liquid crystal. The LCD device has many advantages that make the LCD device popular for use in various fields. The advantages of the LCD device include, for example, thin thickness, low driving voltage, low power consumption, etc. as compared to other types of display devices.

However, the LCD device does not emit light. Thus, the LCD device must use light provided from another device in order to display images. Therefore, the LCD device requires a backlight assembly to provide the LCD device with light.

A conventional backlight assembly employs a cold cathode fluorescent lamp (CCFL). However, as a size of the backlight assembly increases, a number of CCFLs required is also increased. As a result, a cost of manufacturing the backlight assembly is increased and luminance uniformity is decreased.

A planar fluorescent lamp that generates a planar-light has been developed to replace the CCFLs of the conventional backlight assembly. The planar fluorescent lamp includes discharge spaces filled with a discharge gas injected therein. The planar fluorescent lamp has a large size and thin thickness. Therefore, the planar fluorescent lamp is fragile.

Especially, when the planar fluorescent lamp is combined with the backlight assembly and tested for impact, the planar fluorescent lamp may be easily broken.

### SUMMARY OF THE INVENTION

The present invention provides a backlight assembly capable of enhancing stability and impact-absorbability of planar fluorescent lamps. The present invention also provides a liquid crystal display device having the above backlight assembly.

In an exemplary backlight assembly according to the present invention, the backlight assembly includes a bottom chassis, a planar fluorescent lamp, a mold and an inverter. The bottom chassis includes a bottom portion and a side portion. The planar fluorescent lamp generates planar-light. The bottom chassis receives the planar fluorescent lamp. The mold fixes the planar fluorescent lamp such that a gap is generated between a portion of the mold and the planar fluorescent lamp to absorb impact between the mold and the planar fluorescent lamp. The inverter generates discharge voltages to drive the planar fluorescent lamp. For example, the mold includes an upper portion disposed on the side portion of the bottom chassis, and a fixing portion extended from the upper portion toward the bottom portion of the bottom chassis.

In another exemplary backlight assembly according to the present invention, the backlight assembly includes a bottom chassis, a planar fluorescent lamp, a supporting member, a mold and an inverter. The bottom chassis includes a bottom portion and a side portion. The planar fluorescent lamp generates planar-light. The bottom chassis receives the planar fluorescent lamp. The supporting member is interposed between the bottom chassis and the planar fluorescent lamp to support the planar fluorescent lamp. The mold includes an upper portion disposed on the side portion of the bottom chassis, and a fixing portion extended from the upper portion toward the bottom portion of the bottom chassis. The inverter generates discharge voltages to drive the planar fluorescent lamp.

In an exemplary liquid crystal display (LCD) device according to the present invention, the LCD device includes a bottom chassis, a planar fluorescent lamp, a mold, an LCD panel and an inverter. The bottom chassis includes a bottom portion and a side portion. The planar fluorescent lamp generates planar-light. The bottom chassis receives the planar fluorescent lamp. The mold includes an upper portion disposed on the side portion of the bottom chassis, and a fixing portion extended from the upper portion toward the bottom portion of the bottom chassis. The LCD panel is disposed proximate to the planar fluorescent lamp. The LCD panel displays images using the planar-light. The inverter generates discharge voltages to drive the planar fluorescent lamp.

According to the present invention, the planar fluorescent lamp may be fixed stably to the bottom chassis.

### BRIEF DESCRIPTION OF THE DRAWINGS

The above and other features and advantages of the present invention will become more apparent by describing in detailed exemplary embodiments thereof with reference to the accompanying drawings, in which:

FIG. 1 is an exploded perspective view illustrating a backlight assembly according to an exemplary embodiment of the present invention;

FIG. 2 is a perspective view illustrating a mold in FIG. 1;

FIG. 3 is a cross-sectional view illustrating the backlight assembly in FIG. 1;

FIG. 4 is a perspective view illustrating an exemplary embodiment of a planar fluorescent lamp in FIG. 1;

FIG. 5 is a cross-sectional view illustrating the planar fluorescent lamp in FIG. 4;

FIG. 6 is a perspective view illustrating another exemplary embodiment of a planar fluorescent lamp in FIG. 1;

FIG. 7 is a cross-sectional view illustrating the planar fluorescent lamp in FIG. 6;

FIG. 8 is a cross-sectional view illustrating a backlight assembly according to another exemplary embodiment of the present invention;

FIG. 9 is a perspective view illustrating a mold in FIG. 8;

FIG. 10 is a cross-sectional view illustrating a backlight assembly according to still another exemplary embodiment of the present invention;

FIG. 11 is a cross-sectional view illustrating a backlight assembly according to still another exemplary embodiment of the present invention;

FIG. 12 is an exploded perspective view illustrating a backlight assembly according to still another exemplary embodiment of the present invention;

FIG. 13 is a cross-sectional view illustrating the backlight assembly in FIG. 12; and

FIG. 14 is an exploded perspective view illustrating a liquid crystal display device according to an exemplary embodiment of the present invention.

### DETAILED DESCRIPTION OF THE INVENTION

Hereinafter, exemplary embodiments of the present invention will be described in detail with reference to the accompanied drawings.

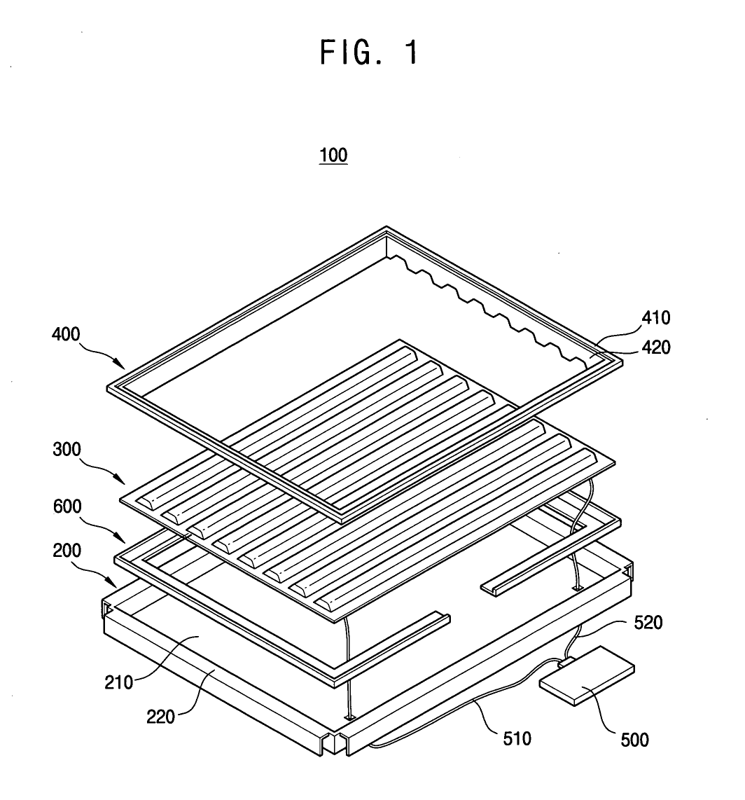

FIG. 1 is an exploded perspective view illustrating a backlight assembly according to an exemplary embodiment of the present invention.

Referring to FIG. 1, a backlight assembly 100 according to the present embodiment includes a bottom chassis (or receiving container) 200, a planar fluorescent lamp 300, a mold 400 and an inverter 500.

The bottom chassis 200 includes a bottom portion 210 and a side portion 220 extended from edge portions of the bottom portion 210 to define a receiving space.

The side portion 220 may include a first portion, a second portion and a third portion. The first portion is extended upwardly from the bottom portion 210 in a direction substantially perpendicular to the bottom portion 210. The second portion is extended from the first portion such that the second portion is substantially parallel with the bottom portion 210. The third portion is extended downwardly from the second portion such that the third portion is substantially parallel with the first portion in order to provide space for combination of the bottom chassis 200 with other members. The bottom chassis 200 may include a material such as, for example, a metal.

The planar fluorescent lamp 300 has a rectangular plate shape corresponding to a shape of the bottom portion 210 of the bottom chassis 200. The receiving space of the bottom chassis 200 receives the planar fluorescent lamp 300. The planar fluorescent lamp 300 generates a planar light. The planar fluorescent lamp 300 includes discharge spaces having discharge gas. When a discharge voltage is applied to the discharge gas, the discharge gas generates an ultraviolet light, which is converted into visible light by a fluorescent layer disposed at an inner surface of the planar fluorescent lamp 300. The planar fluorescent lamp 300 has a large area. Therefore, an internal space of the planar fluorescent lamp 300 is divided into the discharge spaces in order to generate uniform light throughout all portions of the planar fluorescent lamp 300.

The mold 400 is combined with the bottom chassis 200 to fix the planar fluorescent lamp 300. The mold 400 includes an upper portion 410 and a fixing portion 420. The upper portion 410 is substantially parallel with the bottom portion 210 of the bottom chassis 200. The fixing portion 420 is extended downwardly from the upper portion 410 toward the bottom portion 210 of the bottom chassis 200. The upper portion 410 is disposed at the side portion 220 of the bottom chassis 200 and combined with the side portion 220. The fixing portion 420 is extended from IS the upper portion 410 to edge portions of the planar fluorescent lamp 300 to fix the planar fluorescent lamp 300.

The inverter 500 is disposed at a backside of the bottom portion 210 of the bottom chassis 200. The inverter 500 outputs discharge voltages for driving the planar fluorescent lamp 300. The inverter 500 boosts low-level alternating voltages externally provided to be the discharge voltages having a high level. The inverter 500 applies the discharge voltages to the planar fluorescent lamp 300 through a first wire 510 and a second wire 520.

The backlight assembly 100 further includes a supporting member 600. The supporting member 600 is interposed between the bottom chassis 200 and the planar fluorescent lamp 300. The supporting member 600 is disposed such that the supporting member 600 corresponds to the edge portions of the planar fluorescent lamp 300. The supporting member 600 spaces the planar fluorescent lamp 300 apart from the bottom chassis 200, and the supporting member 600 includes a dielectric material. Therefore, the planar fluorescent lamp 300 is electrically insulated from the bottom chassis 200 which may include metal.

The supporting member 600 may include an elastic material, for example, silicone (rubber) in order to reduce impact between the planar fluorescent lamp 300 and the bottom chassis 200. The supporting member 600 may include two pieces having a U-shape. Alternatively, the supporting member 600 may include four pieces corresponding to four sides of the planar fluorescent lamp 300, or corresponding to four edges of the planar fluorescent lamp 300, respectively. Alternatively, the supporting member 600 may have an integrally formed frame shape.

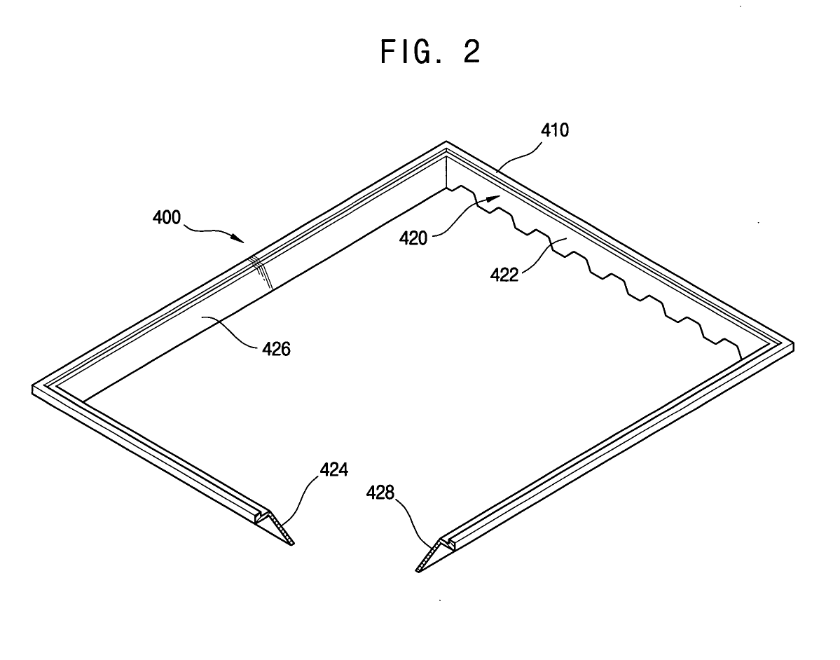

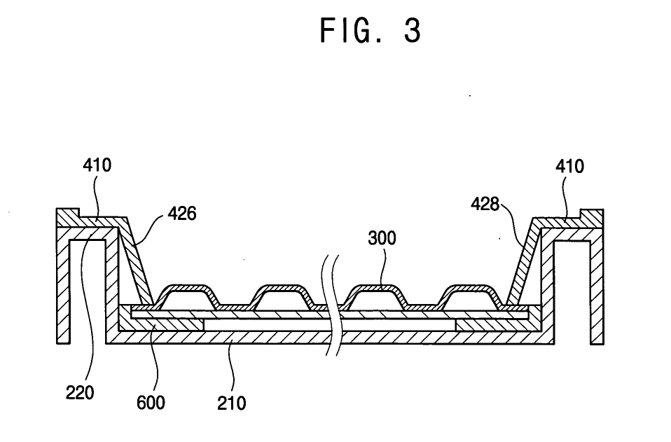

FIG. 2 is a perspective view illustrating a mold in FIG. 1, and FIG. 3 is a cross-sectional view illustrating a backlight assembly in FIG. 1.

Referring to FIGS. 2 and 3, the mold 400 includes the upper portion 410 disposed on the side portion 220 of the bottom chassis 200, and the fixing portion 420 extended from the upper portion 410 toward the planar fluorescent lamp 300.

The fixing portion 420 includes a first reflective plate 422 and a second reflective plate 424 corresponding to short sides of the planar fluorescent lamp 300.

The fixing portion further includes a third reflective plate 426 and a fourth reflective plates 428 corresponding to long sides of the planar fluorescent lamp 300.

Therefore, the first and second reflective plates 422 and 424 are spaced apart from each other and extended substantially parallel to each other. The first and second reflective plates 422 and 424 face each other. The third and fourth reflective plates 426 and 428 are spaced apart from each other and extended substantially parallel to each other. The third and fourth reflective plates 426 and 428 face each other. The third and fourth reflective plates 426 and 428 are substantially perpendicular to the first and second reflective plates 422 and 424 and extend between corresponding opposite end portions of the first and second reflective plates 422 and 424, respectively.

The first and second plates 422 and 424 are extended from the upper portion 410 to fix the short side of the planar fluorescent lamp 300. The first and second plates 422 and 424 may be inclined to form an obtuse angle with respect to the upper portion 410. Therefore, the first and second plates 422 and 424 cover electrodes of the planar fluorescent lamp 300.

The third and fourth reflective plates 426 and 428 are also extended from the upper portion 410 to fix the long side of the planar fluorescent lamp 300. The third and fourth reflective plates 426 and 428 are inclined to form an obtuse angle with respect to the upper portion 410.

The fixing portion 420 including the first, second, third and fourth reflective plates 422, 424, 426 and 428 fixes edge portions of the planar fluorescent lamp 300 to fix the planar fluorescent lamp 300.

In FIG. 2, the mold 400 has an integrally formed frame shape. Alternatively, the mold 400 may be divided into pieces. In other words, the mold 400 may include, for example, two pieces having a U-shape or four pieces having an L-shape.

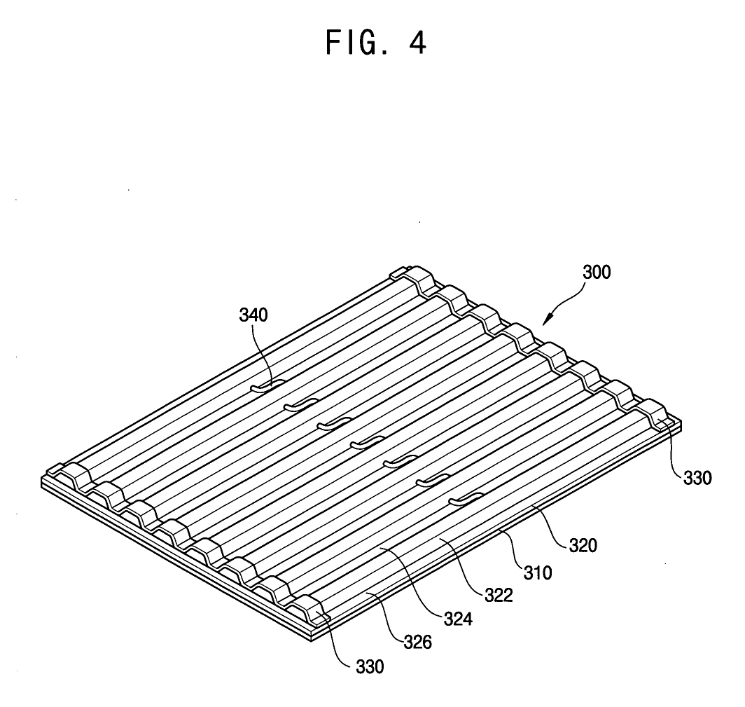

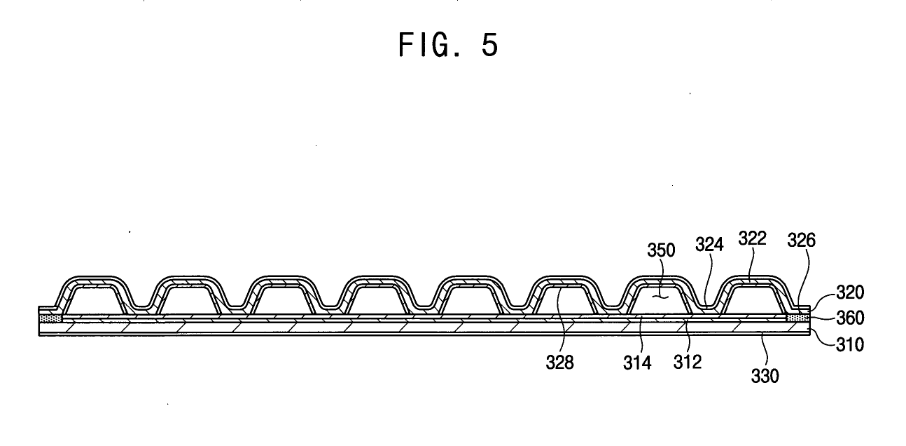

FIG. 4 is a perspective view illustrating an exemplary embodiment of a planar fluorescent lamp in FIG. 1, and FIG. 5 is a cross-sectional view illustrating the planar fluorescent lamp in FIG. 4.

Referring to FIGS. 4 and 5, the planar fluorescent lamp 300 includes a first substrate 310, a second substrate 320 combined with the first substrate 310 to form discharge spaces (or discharge channels) 350, and electrodes 330 that apply discharge voltages to the discharge channels 350.

The first substrate 310 has a flat rectangular plate shape. The first substrate 310 includes an optically transparent material, for example, glass. The first substrate 310 may further include a material for blocking ultraviolet light generated from the discharge channels 350.

The second substrate 320 includes discharge channel portions 322, discharge channel dividing portions 324, and sealing portions 326. The discharge channel portions 322 are spaced apart from the first substrate 310 to define the discharge channels 350. In an exemplary embodiment, the discharge channel portions 322 extend in a direction substantially parallel to the third and fourth reflective plates 426 and 428. The discharge channel dividing portions 324 are interposed between the discharge channel portions 322 and attached to the first substrate 310 to combine the first and second substrates 310 and 320. The sealing portions 326 surrounding the discharge channel portions 322 and the discharge channel dividing portions 324. In other words, the sealing portions 326 are disposed at edge portions of the second substrate 320 and are combined with the first substrate 310.

The second substrate 320 includes an optically transparent material, for example, such as glass. The second substrate 320 may include a material for blocking an ultraviolet light generated from the discharge channels 350.

The second substrate 320 may be formed through a forming process. For example, a base substrate (or metallic pattern) corresponding to the second substrate 320 is heated, and the base substrate compresses a flat substrate to form the second substrate 320 having the discharge channel portions 322, the discharge channel dividing portions 324 and the sealing portions 326. Alternatively, when the base substrate is heated, portions of the base substrate may be formed into the second substrate 320 having the discharge channel portions 322, the discharge channel dividing portions 324 and the sealing portions 326 by inhaling air after the heating.

A cross-section of each of the discharge channel portions 322 has a trapezoidal shape in which edges of the trapezoidal shape are rounded. Therefore, the cross-section of the second substrate 320 includes a plurality of rounded trapezoidal shapes connected to each other. Alternatively, each of the discharge channel portions 322 may have various shapes, for example, a half circle, a rectangular shape, etc.

The second substrate 320 includes connection paths 340. The connection paths 340 connect the discharge channels 350 to each other. For example, neighboring discharge spaces 350 are connected by at least one of the connection paths 340. The discharge channel dividing portions 324 each include at least one of the discharge channels 350. When air is exhausted and discharge gas is injected, the air and the discharge gas move through the connection paths 340.

The connection path 340 is formed through a process of manufacturing the second substrate 320. A shape of the connection paths 340 is not limited as long as the connection paths 340 connect the discharge channels. Each of the connection paths 340 has, for example, an S-shape.

The second substrate 320 is combined with the first substrate 310 through an adhesive 360 such as, for example, frit including glass and metal. The frit has a lower melting point than glass. The adhesive 360 is interposed between the first and second substrates 310 and 320, and the adhesive 360 is heated and cooled down to combine the first and second substrates 310 and 320. The adhesive 360 is interposed only between the sealing portions 326 of the second substrate 320 and the first substrate 310 but not between the discharge channel dividing portions 324 of the second substrate 320 and the first substrate 310. However, the discharge channel dividing portions 324 are compressed toward to the first substrate 310 due to a pressure difference between a pressure of the discharge channels 350 and atmospheric pressure outside of the discharge channels 350. Therefore, the discharge channel dividing portions 324 make contact with the first substrate 310.

When the first and second substrates 310 and 320 are combined with each other, air disposed in the discharge channels 350 is pumped out, and discharge gas for plasma discharge is injected into the discharge channels 350.

The discharge gas includes, for example, mercury (Hg), neon (Ne), argon (Ar), xenon (Xe), krypton (Kr), etc. The discharge gas is injected into the discharge channels 350 until a pressure of the discharge channels 350 to be about 50 torr to about 70 torr. Since atmospheric pressure is about 760 torr, the second substrate 320 is compressed toward the first substrate 310 due to the pressure difference, so that the discharge channel dividing portions 324 make contact with the first substrate 310.

The electrodes 330 are disposed at end portions of the planar fluorescent lamp 300. The electrodes 330 are disposed such that a longitudinal direction of the electrodes 330 is substantially perpendicular to a longitudinal direction of the discharge spaces 350 and the electrodes 330 cross all of the discharge spaces 350.

The electrodes 330 are disposed at an outer face of at least one of the first and second substrates 310 and 320. Alternatively, the electrodes 330 may be disposed at the discharge channels 350 between the first and second substrates 310 and 320. FIG. 4 shows an exemplary embodiment in which the electrodes 330 are disposed at end portions of the outer face of the second substrate 320. FIG. 5 shows an exemplary embodiment in which the electrodes 330 are disposed at end portions of the outer face of the first substrate 310.

The electrodes 330 include a material that is facile to promote easy handling and that has good electrical conductivity. The electrodes 330 may include, for example, silver paste having silver (Ag) and silicon oxide (SiO₂). For example, silver paste may be coated on the outer face of one of the first and second substrates 310 and 320 to form the electrodes 330. Alternatively, metal powder including copper (Cu), nickel (Ni), silver (Ag), gold (Au), chromium (Cr), etc. may be coated on the outer face of one of the first and second substrates 310 and 320 by a spray coating method to form the electrodes 330.

An insulation layer (not shown) may be disposed at the electrodes 330 to protect and electrically insulate the electrodes 330.

The planar fluorescent lamp 300 further includes a reflection layer 312 disposed at an inner face of the first substrate 310, a first fluorescent layer 314 disposed at the reflection layer 312 and a second fluorescent layer 328 disposed at an inner face of the second substrate 320. The first and second fluorescent layers 314 and 328 convert invisible light generated by plasma discharge into visible light. The reflection layer 312 reflects the visible light converted by the first and second fluorescent layers 314 and 328 toward the second substrate 320 to prevent leakage of the visible light.

The reflection layer 312, the first fluorescent layer 314 and the second fluorescent layer 328 are disposed at the first or second substrate 310 or 320, for example, through spraying before the first and second substrates 310 and 320 are combined with each other. The reflection layer 312 and the first fluorescent layer 314 are disposed at an entire inner surface of the first substrate 310 except for the sealing portions 326. In other words, the reflection layer 312 and the first fluorescent layer 314 are disposed at portions of the first substrate 310 corresponding to the discharge channel portions 322 and the discharge channel dividing portions 324. Alternatively, the reflection layer 312 and the first fluorescent layer 314 may be disposed only at portions of the first substrate 310 corresponding to the discharge channel portions 322.

The planar fluorescent lamp 300 may further include a protection layer (not shown). The protection layer may be interposed between the second substrate 320 and the second fluorescent layer 328. The protection layer may be interposed between the first substrate 310 and the reflection layer 312. The protection layer prevents a chemical reaction between mercury (Hg) and the first substrate 310. The protection layer also prevents a chemical reaction between mercury (Hg) and the second substrate 320. Therefore, mercury (Hg) content does not decrease and the planar fluorescent light 300 is not blackened.

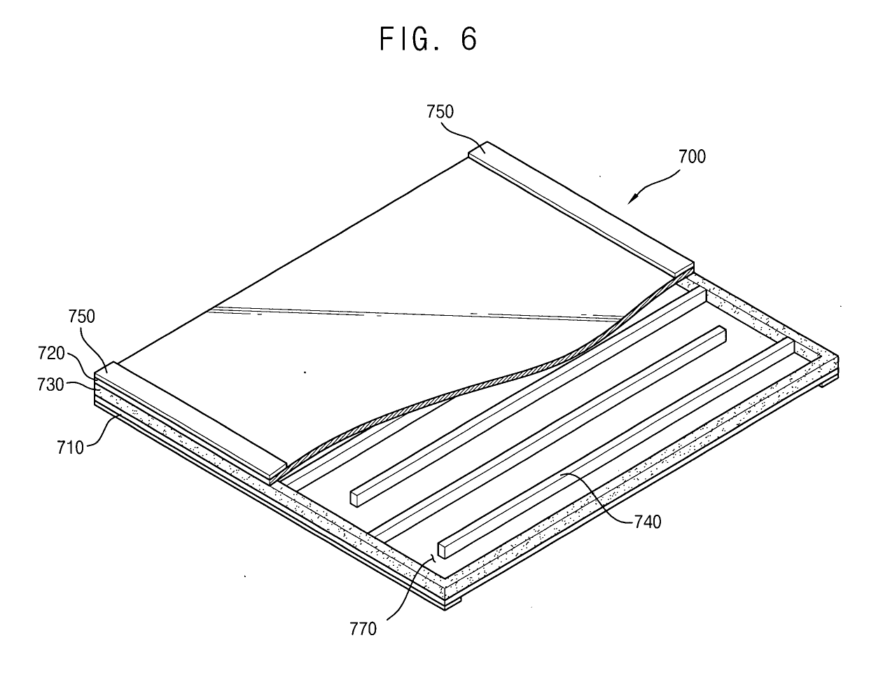

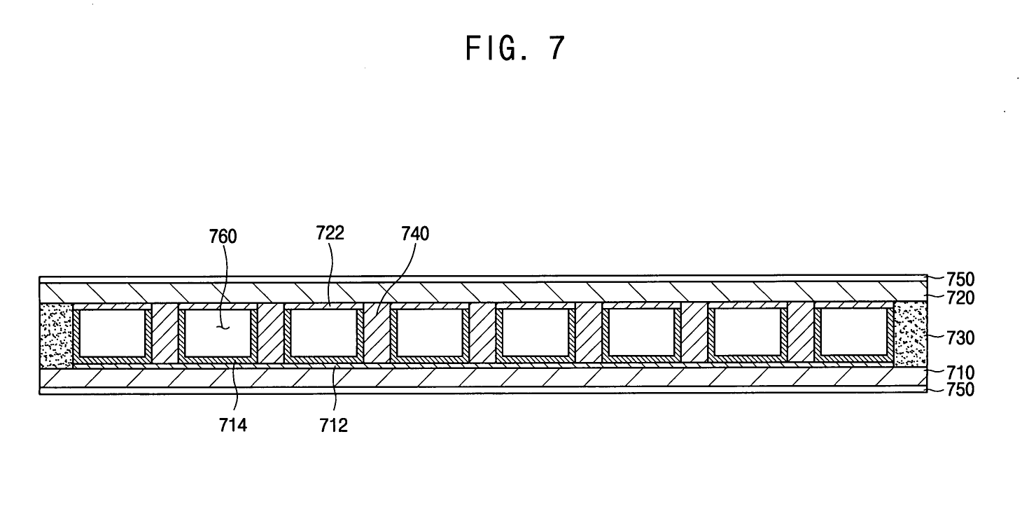

FIG. 6 is a perspective view illustrating another exemplary embodiment of a planar fluorescent lamp in FIG. 1, and FIG. 7 is a cross-sectional view illustrating the planar fluorescent lamp in FIG. 6.

Referring to FIGS. 6 and 7, a planar fluorescent lamp 700 according to the present embodiment includes a first substrate 710, a second substrate 720, a sealing member 730, partition walls 740 and electrodes 750.

The first and second substrates 710 and 720 have a rectangular plate shape. The first and second substrates 710 and 720 include an optically transparent material. The first and second substrates 710 and 720 may include, for example, glass. The first and second substrates 710 and 720 are spaced apart from each other to define an inner space between the first and second substrates 710 and 720. The first and second substrates 710 and 720 may further include material for blocking ultraviolet light.

The sealing member 730 is interposed between the first and second substrates 710 and 720 to combine the first and second substrates 710 and 720. The sealing member 730 seals the inner space defined between the first and second substrates 710 and 720. The sealing member 730 includes, for example, a same material as that of the first and second substrates 710 and 720. The sealing member 730 is attached to edge portions of the first and second substrates 710 and 720 by frit. The frit includes glass and metal. Therefore, the frit has a lower melting point than glass.

The partition walls 740 are interposed between the first and second substrates 710 and 720 to divide the inner space into discharge channels (or discharge spaces) 760. Each of the partition walls 740 has a rod shape. The partition walls 740 are extended along a longitudinal direction of the planar fluorescent lamp 700. The partition walls 740 are spaced apart from each other by a same distance. The partition walls 740 include, for example, a same material as that of the first and second substrates 710 and 720. The partition walls 740 include, for example glass. The partition walls 740 may be attached to the first and second substrates 710 and 720 by an adhesive such as the frit. The partition walls 740 may be formed by a dispenser having, for example, melted glass.

The planar fluorescent lamp 700 includes connection paths 770. The connection paths 770 connect the discharge channels 760 to each other. At least one end of each of the partition walls 740 is spaced apart from the sealing member 730 to define the connection paths 770. For example, first ends of odd numbered partition walls 740 are spaced apart from the sealing member 730 and second ends of the odd numbered partition walls 740 make contact with the sealing member 730. Second ends of even numbered partition walls 740 are spaced apart from the sealing member 730 and first ends of the even numbered partition walls 740 make contact with the sealing member 730. Therefore, the discharge channels 760 are connected to each other to form a serpentine shape through the connection paths 770 that are disposed in a zigzag shape.

Alternatively, both of the first and second ends of the partition walls 740 make contact with the sealing member 730, and a connection hole may be disposed at the partition walls 740. The connection hole may be disposed such that a virtual straight line may not pass through the connection hole of each of the partition walls 740.

The electrodes 750 are disposed at opposite longitudinal end portions of the planar fluorescent lamp 700. Therefore, the electrodes 750 are substantially perpendicular to the partition walls 740, and the electrodes 750 cross all of the discharge channels 760. The electrodes 750 may be disposed at an outer surface of at least one of the first and second substrates 710 and 720. Alternatively, the electrodes 750 may be disposed at an inner surface of at least one of the first and second substrates 710 and 720.

The planar fluorescent lamp 700 further includes a reflection layer 712 disposed at the inner surface of the first substrate 710, a first fluorescent layer 714 disposed at the reflection layer 712, and a second fluorescent layer 722 disposed at the inner surface of the second substrate 720. The first fluorescent layer 714 may be disposed at a side surface of the partition walls 740. The reflection layer 712, and the first and second fluorescent layers 714 and 722 may not be disposed at a region corresponding to the partition walls 740.

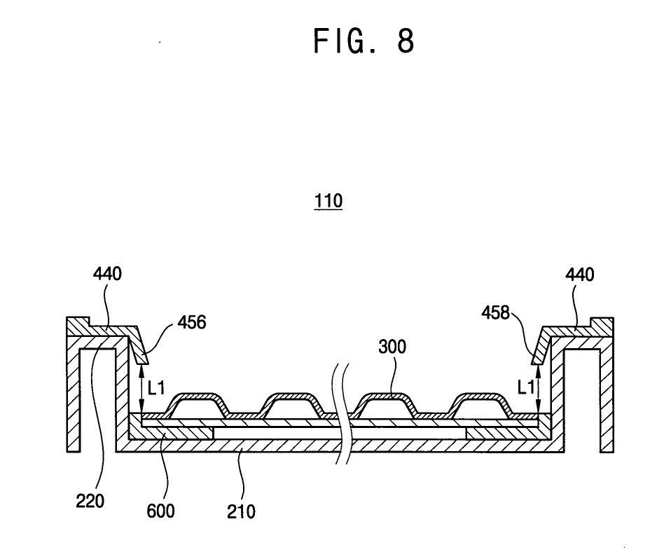

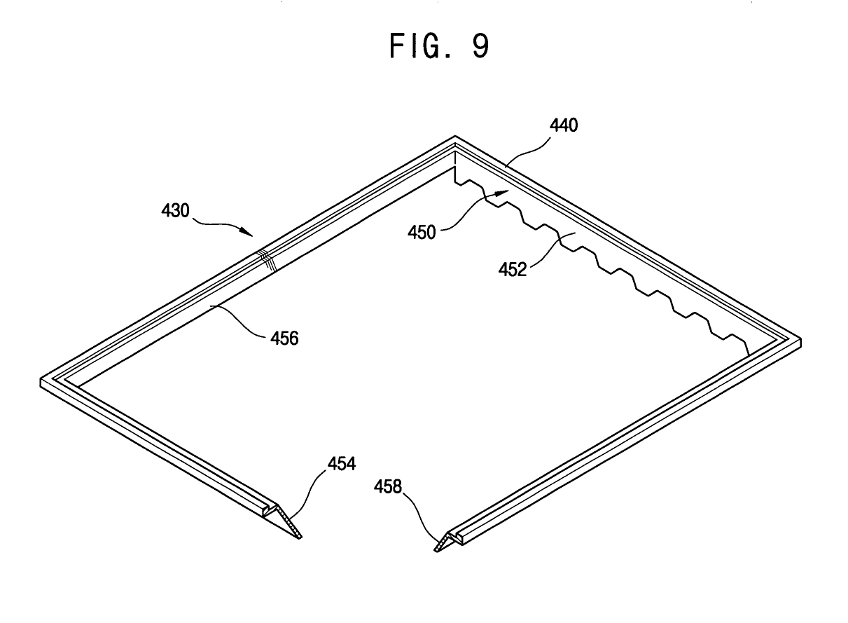

FIG. 8 is a cross-sectional view illustrating a backlight assembly 110 according to another exemplary embodiment of the present invention, and FIG. 9 is a perspective view illustrating a mold in FIG. 8. The backlight assembly 110 of the present embodiment is same as in the backlight assembly 100 of the exemplary embodiment described with reference to FIG. 3 except for the mold. Thus, the same reference numerals will be used to refer to same or like parts as those described in the exemplary embodiment in FIG. 3 and any further explanation will be omitted.

Referring to FIGS. 8 and 9, a mold 430 according to the present embodiment includes an upper portion 440 and a fixing portion 450. The upper portion 440 is substantially parallel to the bottom portion 210 of the bottom chassis 200. The fixing portion 450 is extended downwardly from the upper portion 440 toward the bottom portion 210 of the bottom chassis 200. The upper portion 440 is disposed at the side portion 220 of the bottom chassis 200 and combined with the side portion 220. The fixing portion 450 is extended from the upper portion 440 to edge portions of the planar fluorescent lamp 300 to fix the planar fluorescent lamp 300.

The fixing portion 450 includes a first reflective plate 452 and a second reflective plate 454 corresponding to short sides of the planar fluorescent lamp 300. The fixing portion 450 further includes a third reflective plate 456 and a fourth reflective plate 458 corresponding to long sides of the planar fluorescent lamp 300. Therefore, the first and second reflective plates 452 and 454 extend substantially parallel to each other and face with each other, and the third and fourth reflective plates 456 and 458 extend substantially parallel to each other and face with each other. The third and fourth reflective plates 456 and 458 extend between opposite end portions of the first and second reflective plates 452 and 456, respectively, and are substantially perpendicular to the first and second reflective plates 452 and 456.

The first and second plates 452 and 454 are extended from the upper portion 440 to fix the short side of the planar fluorescent lamp 300. The first and second plates 452 and 454 may be inclined to form an obtuse angle with respect to the upper portion 440. Therefore, the first and second plates 452 and 454 cover electrodes of the planar fluorescent lamp 300.

The third and fourth reflective plates 456 and 458 are also extended from the upper portion 440. The third and fourth reflective plates 456 and 458 are inclined to form an obtuse angle with respect to the upper portion 440. The third and fourth reflective plates 456 and 458 are spaced apart from the planar fluorescent lamp 300 by a reference length L1 in order to increase impact resistance of the planar fluorescent lamp 300. For example, when an impact is applied to the planar fluorescent lamp 300 fixed by the first and second reflective plates 452 and 454, the planar fluorescent lamp 300 may move in a space between the third and fourth reflective plates 456 and 458. Therefore, the impact applied to the planar fluorescent lamp 300 may be alleviated.

Table 1 below shows results of an impact experiment. Values of Table 1 represent a maximum impact that does not break the planar fluorescent lamp 300. Unit of impact acceleration of Table 1 is a gravitational acceleration G.

TABLE 1

Reference length L1 (mm)

| | 0.0 | 4.0 | 6.0 | 9.0 |
|---|---|---|---|---|
| Sample 1(G) | 39.5 | 46.5 | 41.9 | 53.7 |
| Sample 2(G) | 33.4 | 43.4 | 42.5 | 59.2 |

Referring to Table 1, as the reference length L1 increases, an amount of impact acceleration that may be tolerated increases. In other words, as the reference length L1 increases, resistance to impact of the planar fluorescent lamp 300 increases. Especially, when the reference length L1 is about 9.0 mm, the planar fluorescent lamp 300 may resist an impact stronger than about 50 G.

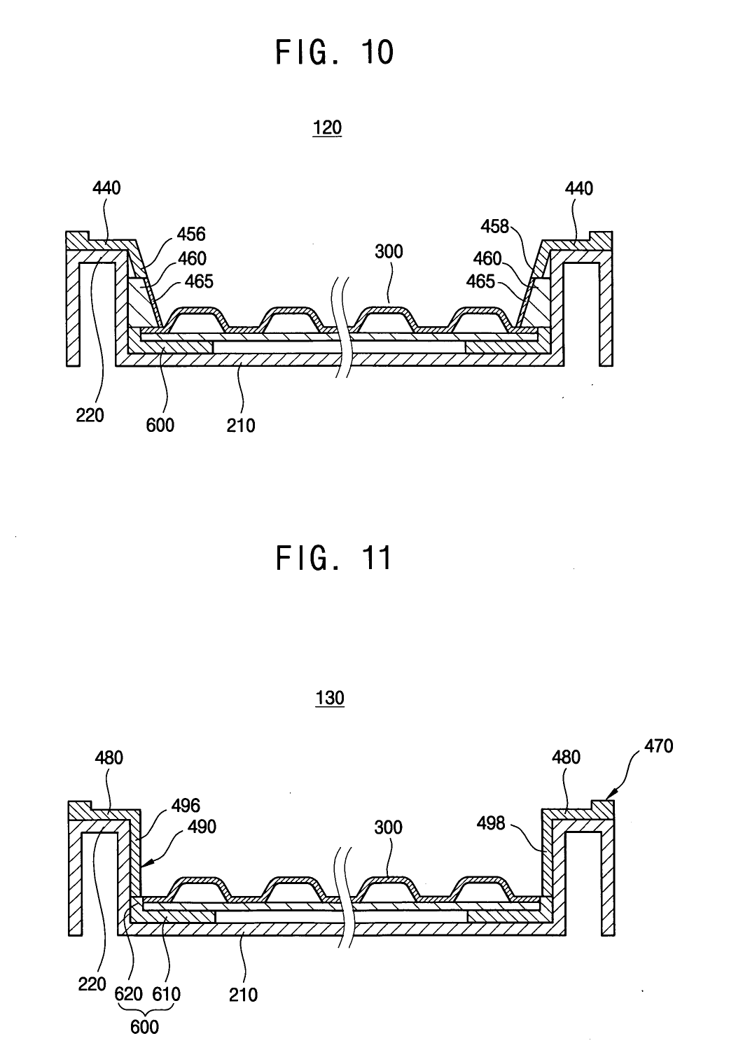

FIG. 10 is a cross-sectional view illustrating a backlight assembly according to still another exemplary embodiment of the present invention. The backlight assembly of the present embodiment is substantially same as in the exemplary embodiment described with reference to FIG. 8 except for an impact-absorbing member. Thus, the same reference numerals will be used to refer to the same or like parts as those described in the embodiment of FIG. 8 and any further explanation will be omitted.

Referring to FIG. 10, a backlight assembly 120 according to the present embodiment further includes an impact-absorbing member 460.

The impact-absorbing member 460 is interposed between third and fourth reflective plates 456 and 458 of a mold 430 and corresponding long edge portions of a planar fluorescent lamp 300. The impact-absorbing member 460 includes a soft material, for example, sponge. Therefore, when an impact is applied to the planar fluorescent lamp 300, the impact-absorbing member 460 absorbs the impact. The impact-absorbing member 460 includes inclined faces such that the third and fourth reflection plates 456 and 458 are flat with respect to the inclined faces of the impact-absorbing member 460. The impact-absorbing member 460 may include a material for reflecting light.

A light-reflecting layer 465 may be formed on the inclined faces of the impact-absorbing member 460. The light-reflecting layer 465 reflects light generated from the planar fluorescent lamp 300.

When the third and fourth reflective plates 456 and 458 are spaced apart from the planar fluorescent lamp 300, a dark light may be displayed on a liquid crystal display panel. Therefore, the impact-absorbing member 460 removes the dark line by reflecting light using the light-reflecting layer 465.

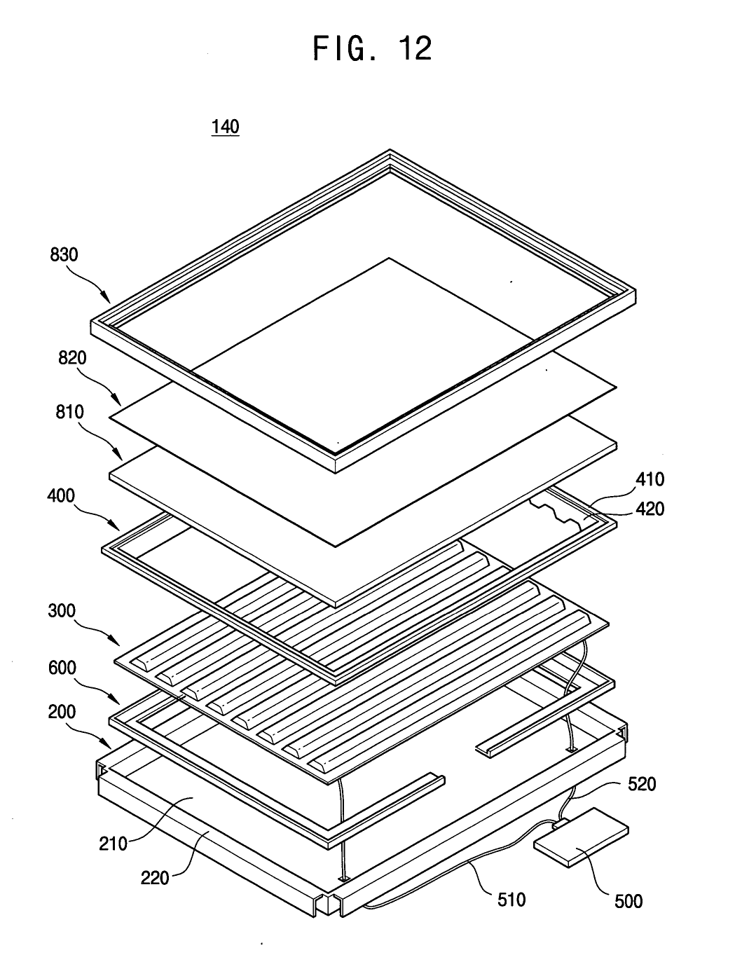

FIG. 11 is a cross-sectional view illustrating a backlight assembly 130 according to still another exemplary embodiment of the present invention. The backlight assembly 130 of the present embodiment is same as in the exemplary embodiment described with reference to FIG. 3 except for a mold. Thus, the same reference numerals will be used to refer to the same or like parts as those described in the exemplary embodiment of FIG. 3 and any further explanation will be omitted.

Referring to FIG. 11, a mold 470 according to the present embodiment includes an upper portion 480 and a fixing portion 490. The upper portion 480 is substantially parallel to the bottom portion 210 of the bottom chassis 200. The fixing portion 490 is extended vertically downward from the upper portion 480 such that the fixing portion 490 is substantially perpendicular to the upper portion 480. The upper portion 480 is disposed on the side portion 220 of the bottom chassis 200 and combined with the side portion 220.

The fixing portion 490 includes first and second reflective plates (not shown) corresponding to short sides of the planar fluorescent lamp 300, and third and fourth reflective plates 496 and 498 corresponding to long sides of the planar fluorescent lamp 300. Therefore, the first and second reflective plates face each other, and the third and fourth reflective plates 496 and 498 face each other. The first and second reflective plates are substantially same as in FIG. 9. Therefore, any further explanation will be omitted.

The supporting member 600 includes a first supporting portion 610 corresponding to a bottom face of the planar fluorescent lamp 300, and a second supporting portion 620 corresponding to a side face of the planar fluorescent lamp 300. The third and fourth reflective plates 496 and 498 are extended vertically downward from the upper portion 480 to make contact with the second supporting portion 620. Therefore, the third and fourth reflective plates 496 and 498 do not limit movement the planar fluorescent lamp 300 to enhance impact resistance of the planar fluorescent lamp 300.

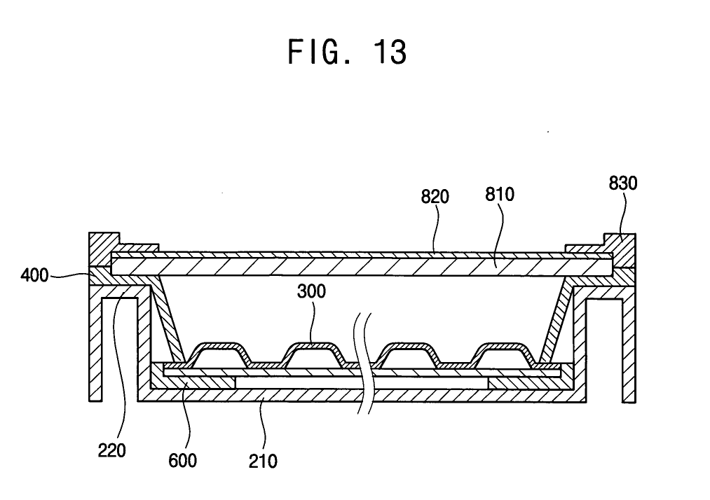

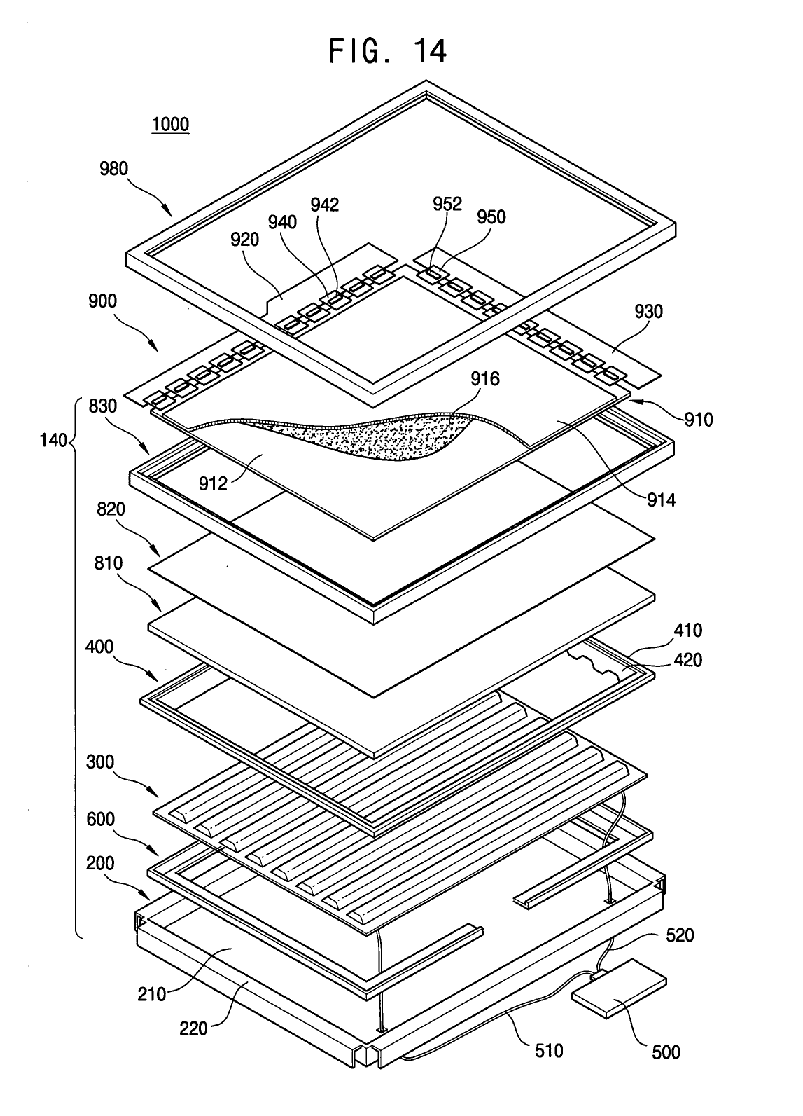

FIG. 12 is an exploded perspective view illustrating a backlight assembly according to still another exemplary embodiment of the present invention, and FIG. 13 is a cross-sectional view illustrating the backlight assembly in FIG. 12. The bottom chassis, the planar fluorescent lamp, the mold, the inverter and the supporting member of the present embodiment are same as in exemplary embodiments in FIGS. 1 to 5. Thus, the same reference numerals will be used to refer to the same parts as those described in with reference to the exemplary embodiments of FIGS. 1 to 5, and any further explanation will be omitted.

Referring to FIGS. 12 and 13, a backlight assembly 140 includes a diffusion plate 810 disposed on the mold 400, an optical sheet 820 disposed on the diffusion plate 810, and a fixing member 830 that fixes the diffusion plate 810 and the optical sheet 820 to the mold 400.

The diffusion plate 810 diffuses light generated by the planar fluorescent lamp 300 to enhance uniformity of the light. The diffusion plate 810 has, for example, a rectangular plate shape. The diffusion plate 810 is disposed on the mold 400, so that the diffusion plate 810 is spaced apart from the planar fluorescent lamp 300.

The optical sheet 820 enhances optical properties of light diffused by the diffusion plate 810. The optical sheet 820 may include a light-condensing sheet that condenses light diffused by the diffusion plate 810 in order to enhance luminance. The optical sheet 820 may include a light-diffusing sheet that diffuses light again in order to enhance luminance uniformity. The backlight assembly 140 may include the optical sheet 820 having sheets with various functions. Alternatively, the backlight assembly 140 may not include the optical sheet 820.

The fixing member 830 has a rectangular frame shape corresponding to the mold 400. The fixing member 830 surrounds and fixes edge portions of the diffusion plate 810 and the optical sheet 830. The fixing member 830 may have pieces having a U-shape or an L-shape.

FIG. 14 is an exploded perspective view illustrating a liquid crystal display device according to an exemplary embodiment of the present invention. The liquid crystal display (LCD) device according to the present embodiment may include one of the backlight assemblies of previous embodiments. Therefore, any further explanation of the backlight assembly will be omitted.

Referring to FIG. 14, an LCD device 1000 according to the present embodiment includes the backlight assembly 140 that generates light, a display unit 900 that displays images using the light, and a top chassis 980 that fixes the display unit 900 to the backlight assembly 140.

The display unit 900 includes an LCD panel 910 that displays images using the light provided by the backlight assembly 140, and data and gate printed circuit boards (PCBs) 920 and 930 for driving the LCD panel 910.

Driving signals outputted from the data and gate printed circuit boards (PCBs) 920 and 930 are applied to the LCD panel 910 through data and gate flexible printed circuits (FPCs) 940 and 950, respectively. The data and gate FPCs 940 and 950 may correspond to tape carrier package (TCP) or chip on film (COF).

The data and gate FPCs 940 and 950 include data and gate driver chips 942 and 952, respectively. The data and gate driver chips 942 and 952 apply the driving signals to LCD panel 910 at proper times.

The LCD panel 910 includes a thin film transistor (TFT) substrate 912, a color filter substrate 914 facing the TFT substrate 912 and a liquid crystal 916 interposed between the TFT substrate 912 and the color filter substrate 914.

The TFT substrate 912 includes a glass substrate having TFTs disposed thereon. The TFTs are arranged in a matrix shape. Each of the TFTs includes a source electrode that is electrically connected to one of source lines, a gate electrode that is electrically connected to one of gate lines, and a drain electrode that is electrically connected to a pixel electrode. The pixel electrode includes an optically transparent and electrically conductive material such as indium tin oxide (ITO), indium zinc oxide (IZO), etc.

The color filter substrate 914 includes a glass substrate having red, green and blue color filters disposed thereon. The color filter substrate 914 also includes a common electrode including optically transparent and electrically conductive material such as ITO, IZO, etc.

When a gate voltage is applied to the gate electrode of the TFT, the TFT is turned on, so that a pixel voltage is applied to the pixel electrode through the TFT. Therefore, electric fields are formed between the pixel electrode of the TFT substrate 912 and the common electrode of the color filter substrate 914.

When the electric fields are applied to the liquid crystal 916 between the pixel electrode and the common electrode, molecules of the liquid crystal 916 are rearranged to change optical transmittance to display black and white images. The black and white images are converted into color images by the color filters of the color filter substrate 914.

The top chassis 980 surrounds edge portions of the LCD panel 910 and is combined with the bottom chassis 200 to fix the LCD panel 910 to the backlight assembly 140. The top chassis 980 protects the LCD panel 910 and prevents the LCD panel 910 from drifting with respect to the backlight assembly 140.

According to the present invention, a planar fluorescent lamp may be fixed stably to a bottom chassis. Furthermore, when reflective plates corresponding to long side edges of the planar fluorescent lamp are spaced apart from the planar fluorescent lamps, impact resistance is enhanced. Additionally, when an impact-absorbing member having a light reflecting layer formed thereon is interposed between the long side edges of the planar fluorescent lamp and the reflective plate, a dark line displayed on the LCD panel may be removed.

Having described exemplary embodiments of the present invention and its advantages, it is noted that various changes, substitutions and alterations can be made herein without departing from the spirit and scope of the invention as defined by appended claims.

What is claimed is:

1. A backlight assembly comprising:
a bottom chassis including a bottom portion and a side portion;
a planar fluorescent lamp that generates planar-light, the planar fluorescent lamp being received by the bottom chassis;
a mold that fixes the planar fluorescent lamp such that a gap is generated between a portion of the mold and the planar fluorescent lamp to absorb impact between the mold and the planar fluorescent lamp; and
an inverter that generates discharge voltages to drive the planar fluorescent lamp.

2. The backlight assembly of claim 1, wherein the mold comprises an upper portion disposed at the side portion of the bottom chassis, and a fixing portion extended from the upper portion toward the bottom portion of the bottom chassis.

3. The backlight assembly of claim 2, wherein the fixing portion comprises:
a first reflective plate disposed at a first side of the planar fluorescent lamp and a second reflective plate disposed at a second side of the planar fluorescent lamp, the first and second sides extending substantially parallel to one another; and
a third reflective plate disposed at a third side of the planar fluorescent lamp and a fourth reflective plate disposed at a fourth side of the planar fluorescent lamp, the third and fourth sides being substantially perpendicular to the first and second sides, the third side extending between a first end of the first side and a first end of the second side, the fourth side extending between a second end of the first side and a second end of the second side, and the first and second sides being shorter than the third and fourth sides.

4. The backlight assembly of claim 3, wherein the first and second reflective plates compress edges of the planar fluorescent lamp toward the bottom chassis.

5. The backlight assembly of claim 3, wherein the third and fourth reflective plates are spaced apart from the planar fluorescent lamp by a reference length.

6. The backlight assembly of claim 5, wherein the reference length is substantially equal to or greater than about 9mm.

7. The backlight assembly of claim 5, further comprising impact-absorbing members interposed between the planar fluorescent lamp and the third and fourth reflective plates.

8. The backlight assembly of claim 7, wherein the impact-absorbing members include a light-reflecting layer disposed at a surface of each of the impact-absorbing members.

9. The backlight assembly of claim 1, wherein the planar fluorescent lamp comprises:
a first substrate;
a second substrate including discharge channel portions spaced apart from the first substrate to define discharge channels, discharge channel dividing portions interposed between the discharge channel portions, and sealing portions formed along edges of the second substrate, the sealing portions of the second substrate being attached to the first substrate to combine the first and second substrates; and
electrodes that apply the discharge voltages to the discharge channels.

10. The backlight assembly of claim 1, wherein the planar fluorescent lamp comprises:
a first substrate;
a second substrate spaced apart from the first substrate;
at least one partition wall interposed between the first and second substrates to divide a space between the first and second substrates into discharge channels; and
electrodes that apply the discharge voltages to the discharge channels.

11. The backlight assembly of claim 1, further comprising:
a supporting member interposed between the bottom chassis and the planar fluorescent lamp to support the planar fluorescent lamp;
a diffusion plate disposed at the mold; and
a fixing member that fixes the diffusion plate to the mold.

12. A backlight assembly comprising:
a bottom chassis including a bottom portion and a side portion;
a planar fluorescent lamp that generates planar-light, the planar fluorescent lamp being received by the bottom chassis;
a supporting member interposed between the bottom chassis and the planar fluorescent lamp to support the planar fluorescent lamp;
a mold including an upper portion disposed on the side portion of the bottom chassis, and a fixing portion extended from the upper portion toward the bottom portion of the bottom chassis; and
an inverter that generates discharge voltages to drive the planar fluorescent lamp.

13. The backlight assembly of claim 12, wherein the supporting member comprises:
a first supporting portion corresponding to a bottom face of the planar fluorescent lamp; and
a second supporting portion corresponding to a side face of the planar fluorescent lamp.

14. The backlight assembly of claim 13, wherein the fixing portion comprises:
a first reflective plate disposed at a first side of the planar fluorescent lamp and second reflective plate disposed at a second side of the planar fluorescent lamp, the first and second sides being substantially parallel to one another; and
a third reflective plate disposed at a third side of the planar fluorescent lamp and a fourth reflective plate disposed at a fourth side of the planar fluorescent lamp, the third and fourth sides being substantially perpendicular to the first and second sides, the third side extending between a first end of the first side and a first end of the second side, the fourth side extending between a second end of the first side and a second end of the second side, and the first and second sides being shorter than the third and fourth sides.

15. The backlight assembly of claim 14, wherein the first and second reflective plates compress edges of the planar fluorescent lamp toward the bottom chassis.

16. The backlight assembly of claim 14, wherein the third and fourth reflective plates are extended in a direction substantially perpendicular to the upper portion of the mold to be disposed at the second supporting portion of the supporting member.

17. The backlight assembly of claim 16, further comprising:
a diffusion plate disposed on the mold;
an optical sheet disposed on the diffusion plate; and
a fixing member that fixes the diffusion plate and the optical sheet to the mold.

18. A liquid crystal display (LCD) device comprising:
a bottom chassis including a bottom portion and a side portion;
a planar fluorescent lamp that generates planar-light, the planar fluorescent lamp being received by the bottom chassis;
a mold including upper portion disposed on the side portion of the bottom chassis, and a fixing portion extended from the upper portion toward the bottom portion of the bottom chassis;
an LCD panel disposed proximate to the planar fluorescent lamp, the LCD panel displaying images using the planar-light; and
an inverter that generates discharge voltages to drive the planar fluorescent lamp.

19. The LCD device of claim 18, wherein the fixing portion comprises:
a first reflective plate disposed at a first side of the planar fluorescent lamp and a second reflective plate disposed at a second side of the planar fluorescent lamp and compressing edges of the planar fluorescent lamp toward the bottom chassis; and
a third reflective plate disposed at a third side of the planar fluorescent lamp and a fourth reflective plate disposed at a fourth side of the planar fluorescent lamp, the third and fourth sides being substantially perpendicular to the first and second sides, the third side extending between a first end of the first side and a first end of the second side, the fourth side extending between a second end of the first side and a second end of the second side, and the first and second sides being shorter than the third and fourth sides.

20. The LCD device of claim 19, wherein the third and fourth reflective plates are spaced apart from the planar fluorescent lamp by a reference length.

21. The LCD device of claim 20, further comprising impact-absorbing members interposed between the planar fluorescent lamp, and the third and fourth reflective plates.

22. The LCD device of claim 21, wherein the impact-absorbing members include a light-reflecting layer disposed at a surface of each of the impact-absorbing members.

23. The LCD device of claim 19, further comprising a supporting member interposed between the bottom chassis and the planar fluorescent lamp to support the planar fluorescent lamp.

24. The LCD device of claim 23, wherein the supporting member comprises:
a first supporting portion corresponding to a bottom face of the planar fluorescent lamp; and
a second supporting portion corresponding to a side face of the planar fluorescent lamp.

25. The LCD device of claim 24, wherein the third and fourth reflective plates are extended in a direction substantially perpendicular to the upper portion of the mold to contact the second supporting portion of the supporting member.

26. The LCD device of claim 18, further comprising:
a diffusion plate disposed at the mold;
an optical sheet disposed at the diffusion plate;
a fixing member that fixes the diffusion plate and the optical sheet to the mold and supports the LCD panel; and
a top chassis that fixes the LCD panel to the fixing member.
